(19) United States
(12) Patent Application Publication
(10) Pub. No.: US 2013/0173453 A1
(43) Pub. Date: Jul. 4, 2013

(54) System and Method for Evaluating Loans and Collections Based Upon Vehicle History

(71) Applicant: CARFAX, INC., Centreville, VA (US)

(72) Inventors: Richard T. Raines, Arlington, VA (US); Stephen John Walter, Leesburg, VA (US); Eric J. Nesson, Falls Church, VA (US); Ian Bush, Round Hill, VA (US); David Allen Lackey, Washington, DC (US)

(73) Assignee: CARFAX, INC., Centreville, VA (US)

(21) Appl. No.: 13/779,231

(22) Filed: Feb. 27, 2013

Related U.S. Application Data
(63) Continuation-in-part of application No. 12/572,723, filed on Oct. 2, 2009.
Application No. 12/572,723 is a continuation-in-part of application No. 12/105,996, filed on Apr. 18, 2008.
(60) Provisional application No. 60/907,899, filed on Apr. 20, 2007.

(51) Int. Cl. G06Q 40/02

(52) U.S. Cl. CPC G06Q 40/025
USPC 705/38

(57) ABSTRACT

A method of determining risk of financing a vehicle may include identifying a vehicle and forming, in a physical memory of a data processing system, a plurality of data groupings using a processing device of the data processing system, wherein each of the plurality of data groupings includes at least one vehicle history data variable of the identified vehicle. The method may also include processing the at least one vehicle history data variable of at least one data grouping of the plurality of data groupings using the processing device of the data processing system and determining an overall value of the at least one data grouping using the processing device of the data processing system. The method may further include determining a risk of financing the identified vehicle based on the overall value of the at least one data grouping, using the processing device of the data processing system.

### CROSS-REFERENCE TO RELATED APPLICATIONS

This application is a continuation-in-part of U.S. patent application Ser. No. 12/572,723, filed on Oct. 2, 2009, which is a continuation-in-part application of U.S. patent application Ser. No. 12/105,996, filed on Apr. 18, 2008, which claims priority to U.S. Provisional Application No. 60/907,899, filed on Apr. 20, 2007, the disclosures of which are herein incorporated in their entirety by reference.

### FIELD OF THE DISCLOSURE

The present disclosure relates generally to a system and method of evaluating loans and collections. In particular, the present disclosure is directed to a system and method of evaluating vehicle loans and collections based on vehicle history attributes.

### BACKGROUND OF THE DISCLOSURE

The vehicle industry is one of the largest industries in many industrialized regions of the world. As a result, the market for vehicles, especially automobiles, has evolved into a substantial market. Also, with the increased popularity of the automobiles in many industrialized regions of the world, vehicle loans are becoming more common. In a vehicle loan, the borrower initially receives or borrows an amount of money from a lender, and is obligated to pay back or repay the loan amount in regular installments during a specified period of time (e.g., 3-5 years). The vehicle loan generally provides for the payment of an additional cost in the form of an interest payment which provides an incentive for the lender to engage in the vehicle loan. However, fraud and vehicle loan defaults cost the finance industry tremendous amounts of money. Therefore, when a vehicle loan is made, it is important to assess the risks involved with such vehicle loan. Lending companies that finance vehicle loans, such as vehicle finance companies, often rely on the credit score of a borrower in order to determine the risk of a particular vehicle loan.

This type of solution is failing today because even borrowers with high credit scores sometimes default or miss payments on their vehicle loans. Also, many borrowers who may have low credit scores do not default or miss payments on their vehicle loans. Therefore, it may be difficult for vehicle finance companies to assess the risk associated with vehicle loans based solely on the credit score of the borrowers. Thus, there is a need for a system and method to accurately assess the risk associated with vehicle loans and collections.

### SUMMARY OF THE DISCLOSURE

The foregoing needs are met, to a great extent, by the present invention, wherein in one aspect a system and method of evaluating vehicle loans and collections based on vehicle history attributes is provided.

In accordance with one embodiment of the present disclosure, a method of determining risk of financing a vehicle is provided. The method may include identifying a vehicle and forming, in a physical memory of a data processing system, a plurality of data groupings using a processing device of the data processing system, wherein each of the plurality of data groupings includes at least one vehicle history data variable of the identified vehicle. The method may also include processing the at least one vehicle history data variable of at least one data grouping of the plurality of data groupings using the processing device of the data processing system and determining an overall value of the at least one data grouping using the processing device of the data processing system. The method may further include determining a risk of financing the identified vehicle based on the overall value of the at least one data grouping, using the processing device of the data processing system.

In accordance with another embodiment of the present disclosure, an apparatus for determining risk of financing a vehicle is provided. The apparatus may include means for identifying a vehicle and means for forming a plurality of data groupings, wherein each of the plurality of data groupings includes at least one vehicle history data variable of the identified vehicle. The apparatus may also include means for processing the at least one vehicle history data variable of at least one data grouping of the plurality of data groupings and means for determining an overall value of the at least one data grouping. The apparatus may further include means for determining a risk of financing the identified vehicle based on the overall value of the at least one data grouping.

There has thus been outlined, rather broadly, certain embodiments of the invention in order that the detailed description thereof herein may be better understood, and in order that the present contribution to the art may be better appreciated. There are, of course, additional embodiments of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of embodiments in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

In order to facilitate a fuller understanding of the present disclosure, reference is now made to the accompanying drawings, in which like elements are referenced with like numerals. These drawings should not be construed as limiting the present disclosure, but are intended to be illustrative only.

FIG. 1 is a general schematic illustration of a vehicle history information computer system according to an embodiment of the present disclosure.

FIG. 2 is a detailed schematic illustration of the vehicle history information computer system according to an embodiment of the present disclosure.

FIG. 3 is a diagrammatic view of accumulated data for identifying a vehicle according to an embodiment of the present disclosure.

FIG. 4 is a diagrammatic view of various data groupings according to an embodiment of the present disclosure.

FIG. 5 is a flowchart providing a general overview of an exemplary risk evaluation process according to an embodiment of the present disclosure.

FIG. 6 is a flowchart of an exemplary risk evaluation of a vehicle financing transaction according to an embodiment of the present disclosure.

FIG. 7 is a flowchart of risk evaluation in a frame damage scenario according to an embodiment of the present disclosure.

FIG. 8 is a flowchart of risk evaluation in an accident scenario according to an embodiment of the present disclosure.

FIG. 9 is a flowchart of risk evaluation in an odometer rollback scenario according to an embodiment of the present disclosure.

FIG. 10 is a flowchart of risk evaluation in a rate adjustment/non-personal ownership flag scenario according to an embodiment of the present disclosure.

FIG. 11 is a flowchart of risk evaluation in a high mileage scenario according to an embodiment of the present disclosure.

FIG. 12 is a flowchart of risk evaluation in a value adjustment flags scenario according to an embodiment of the present disclosure.

FIG. 13 is a flowchart of risk evaluation in a VIN clone flag-export scenario according to an embodiment of the present disclosure.

FIG. 14 is a flowchart of risk evaluation in a VIN clone flag-extended inactive scenario according to an embodiment of the present disclosure.

FIG. 15 is a flowchart of risk evaluation in a VIN clone flag-inactive scenario according to an embodiment of the present disclosure.

FIG. 16 is a flowchart of risk evaluation in a VIN clone flag-multiple registration scenario according to an embodiment of the present disclosure.

### DETAILED DESCRIPTION OF EMBODIMENTS

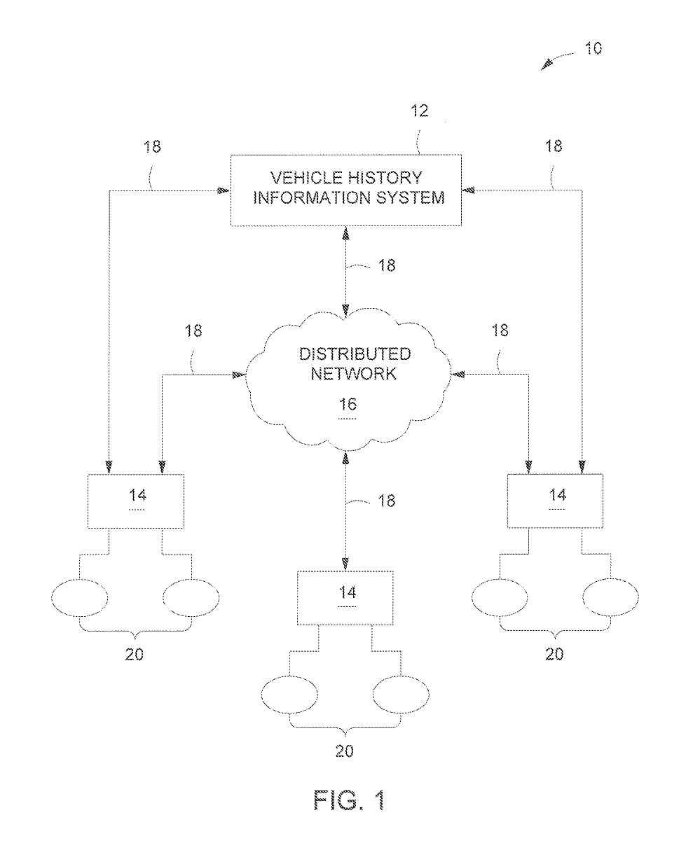

FIG. 1 is a schematic diagram of a computer system according to an embodiment of the present disclosure that can be used to evaluate vehicle loans and collections. Initially, it should be understood that the term “default” describes in this context a current set of nonpayment events associated with a vehicle financing transaction. The term “vehicle” is used broadly herein to encompass any sort of transportation device. For example, vehicles include automobiles of all types, motorized cycles including motorcycles and all-terrain vehicles, boats, watercraft, airplanes, etc. The embodiments of the present disclosure may be implemented in the manner described to determine risk of a financing transaction for such vehicles. Also, the embodiments of the present disclosure may be implemented in the manner described to evaluate vehicle loans and collections.

FIG. 1 is a schematic diagram of a system, in the form of a networked computer system 10, designed to implement various embodiments of the present disclosure. FIG. 1 may also be viewed as showing the relationship of the different entities potentially involved in the application of embodiments of the present disclosure. Specifically, a computer implemented vehicle history information system 12 exchanges data with one or more remote terminals 14 through data transmission across a distributed network 16, e.g. the Internet. Alternatively, the one or more remote terminals 14 may communicate directly with the vehicle history information system 12. The remote terminals 14 are associated with an entity (e.g., an insurance company or a finance company) that may access vehicle history information system 12, as discussed more fully herein below, to obtain vehicle history information for providing assessments about a risk associated with vehicle loans and collections.

The vehicle history information system 12 may be linked to one or more vehicle history data providers (not illustrated) that may provide information about the events in the real world to allow the vehicle history information system administrator to receive and update vehicle history information in the vehicle history information system 12. The vehicle history data providers may be individual consumers, vehicle dealers, state titling offices, Department of Motor Vehicles (DMVs), auto auctions and/or any other source of vehicle information.

The remote terminal 14 may be a mobile user device, a computer, a personal computer, a laptop, a cellular communication device, a workstation, a mobile device, a phone, a television, a handheld PC, a personal digital assistant (PDA), a thin system, a fat system, a network appliance, an Internet browser, or other any other device that may be in communication with the vehicle history information system 12 via the distributed network 16. Other remote terminals 14 may be one or more intermediary devices that may communicate with the distributed network 16, such as a transmitter/receiver, router, modem, or a set-top box. The remote terminal 14 may be coupled to the vehicle history information system 12 via a wired link. In another exemplary embodiment, the remote terminal 14 may be coupled to the vehicle history information system 12 via a wireless link.

The remote terminals 14 may be in communication with the vehicle history information system 12 via the distributed network 16. The distributed network 16 may be a wireless network, a wired network or any combination of wireless network and wired network. For example, the distributed network 16 may include one or more of a fiber optics network, a passive optical network, a cable network, an Internet network, a satellite network (e.g., operating in Band C, Band Ku or Band Ka), a wireless LAN, a Global System for Mobile Communication (GSM), a Personal Communication Service (PCS), a long term evolution (LTE), a Personal Area Network (PAN), D-AMPS, Wi-Fi, Fixed Wireless Data, IEEE 802.11 and 802.15.1 or any other wired or wireless network for transmitting and receiving a data signal. In addition, the distributed network 16 may include, without limitation, telephone line, fiber optics, IEEE Ethernet 802.3, wide area network (WAN), local area network (LAN), or global network such as the Internet. The distributed network 16 may support an Internet network, a wireless communication network, a cellular network, or the like, or any combination thereof. Thus, remote terminals 14 may be connected to the distributed network 16 by any communication links 18, including hardwired and/or wireless links.

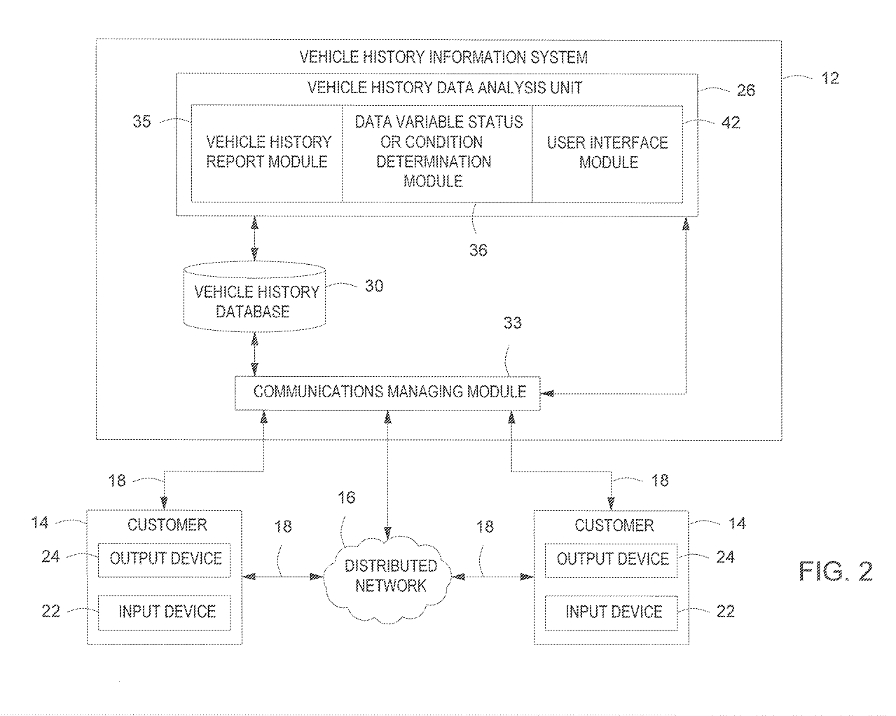

FIG. 2 illustrates in more detail the vehicle history information system 12 according to an embodiment of the present disclosure. Generally, vehicle history information system 12 may be implemented with any type of appropriate hardware and/or software, and can be embodied as computer readable storage media having executable instructions, and/or a computer architecture of computing devices as discussed herein below. Vehicle history information system 12 may be implemented using a server, a personal computer, a portable computer, a thin client, or any other computing device, such as a handset, or any combination of such devices. In this regard, vehicle history information system 12 may be a single device at a single location as shown, or multiple devices at a single location, or multiple locations that are connected together using any appropriate communication protocols over any communication medium.

The vehicle history information system 12 may include a UNIX based server, Windows 2000 Server, Microsoft IIS server, Apache HTTP server, API server, Java sever, Java Servlet API server, ASP server, PHP server, HTTP server, Mac OS X server, Oracle server, IP server, or other independent server to provide vehicle history information to the remote terminal 14. Also, the vehicle history information system 12 may include one or more Internet Protocol (IP) network server or public switch telephone network (PSTN) server.

The vehicle history information system 12 may include one or more storage devices including, without limitation, paper card storage, punched card, tape storage, paper tape, magnetic tape, disk storage, gramophone record, floppy disk, hard disk, ZIP disk, holographic, molecular memory. The one or more storage devices may also include, without limitation, optical disc, CD-ROM, CD-R, CD-RW, DVD, DVD-R, DVD-RW, DVD+R, DVD+RW, DVD-RAM, Blu-ray, Minidisc, HVD and Phase-change Dual storage device. The one or more storage devices may further include, without limitation, magnetic bubble memory, magnetic drum, core memory, core rope memory, thin film memory, twistor memory, flash memory, memory card, semiconductor memory, solid state semiconductor memory or any other like mobile storage devices.

FIG. 2 also illustrates in more detail of the implementation of the remote terminals 14 according to an embodiment of the present disclosure. Although only two remote terminals 14 are shown in detail as the customer remote terminals 14 which represent the entities (e.g., insurance companies or finance companies) of FIG. 1, it should be appreciated that any number of remote terminals 14 may be implemented in communication with the distributed network 16. Remote terminal 14 may be any appropriate computing device for accessing vehicle history information system 12 such as a personal computer, a portable computer, a thin client, a handheld device such as a mobile phone handset or PDA, and the like. Remote terminal 14 may include an input device 22 and an output device 24 which may allow the user of the remote terminal 14 to provide information to, and receive information from, the vehicle history information system 12 via the distributed network 16. The input device 22 may include a keyboard, mouse, etc. as well as memory devices based on magnetic, optical and/or solid state technologies including disc drives, CD/DVD drives, flash memory, etc. The output device 24 may include a monitor screen, printer, etc. that may allow the user of the remote terminal 14 to obtain the vehicle history information from vehicle history information system 12.

Referring again to FIG. 2, the vehicle history information system 12 may include a vehicle history data analysis unit 26 comprising a computer processor, a vehicle history database 30 comprising a non-transitory storage medium, and a communications managing module 33 comprising a computer processor, all of which are connected together for effective data communication. Vehicle history data analysis unit 26, in the implementation shown, may include a vehicle history report module 35 comprising a computer processor, a data variable status or condition determination module 36 comprising a computer processor, and a user interface module 42 comprising a graphical user interface (GUI) or application programming interface (API), the functions of each being further described herein below.

The presence of various levels of risk for a vehicle financing transaction may be determined by a data variable status or condition determination module 36, which works in conjunction with a vehicle history report module 35 and a user interface module 42 to provide an interactive analysis of the risk situation associated with the vehicles being considered. This information is fed to the remote terminals 14 via the distributed network 16, and the customers interact with the vehicle history information system 12 via their remote terminals 14 through their input devices 22 and output devices 24.

The vehicle loans and collections or a portfolio of loans and collections may be evaluated by a data variable status or condition determination module 36, which works in conjunction with a vehicle history report module 35 and a user interface module 42 to provide an interactive analysis of the risks associated with the vehicle loans and collections or the portfolio of loans and collections being considered. This information is fed to the remote terminals 14 via the distributed network 16, and the customers interact with the vehicle history information system 12 via their remote terminals 14 through their input devices 22 and output devices 24.

Vehicle history database 30 may contain a plurality of vehicle history datasets which are collections of vehicle history data arranged, organized, indexed and/or retrievable based on a unique indicator such as the unique vehicle identification number (such as VIN for automobiles) of a particular vehicle. Each vehicle sold within the United States and most foreign countries has a unique identification number which is identified on nearly every vehicle title issued and physically identified on the respective vehicle. The identification may be used to identify and trace the public record of each particular vehicle and to associate different vehicle data collected from a variety of sources with the particular vehicle.

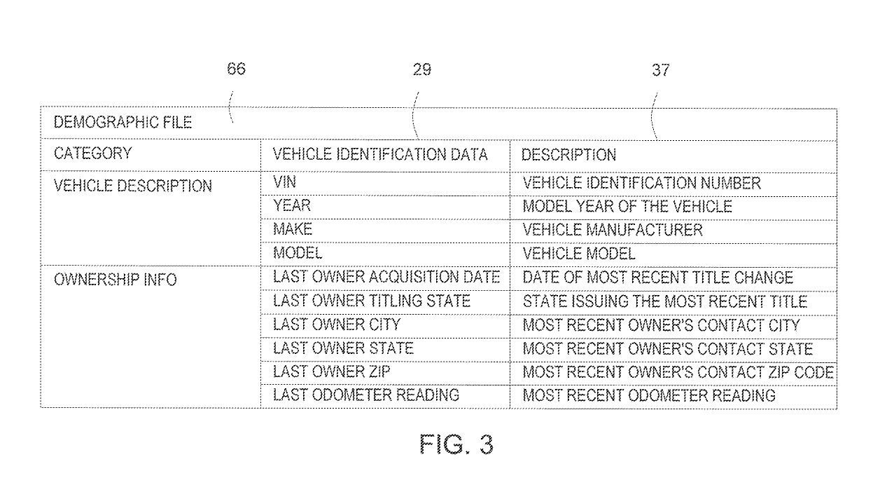

FIG. 3 shows an information architecture for vehicle history database 30 according to an embodiment of the present disclosure. As shown in FIG. 3, a demographic file 66 may store information about a vehicle, and vehicle identification data 29 may store a series of attributes such as VIN, year, make and model which are paired with description 37, which would be the actual value of those variables for a vehicle. The information architecture such as this may allow retrieval of information about vehicles in the context of a vehicle history database 30.

It should be noted that the vehicle history information system 12 and the vehicle history data analysis unit 26 according to an embodiment of the present disclosure is illustrated and discussed herein as having various modules which perform particular functions and interact with one another. It should be understood that these modules are merely segregated based on their function for the sake of description and do not necessarily represent discrete hardware or software code which is stored on a non-transitory computer-readable medium for execution on appropriate computing hardware such as a processor. In this regard, these modules, units and other components may be hardware and/or software stored on a non-transitory computer-readable medium for execution on appropriate computing hardware, such as a computer processor, and may be thus implemented to substantially perform their particular functions explained herein. The various functions of the different modules and units that comprise computer processor can be combined or segregated as hardware and/or software stored on a non-transitory computer-readable medium as above as modules in any manner, and can be used separately or in combination.

It should be clarified that as used herein, the term “vehicle” may be referred to one particular, physical vehicle associated with a single identification number and may not refer to general model level information or categories of vehicles. Such general model level information relating to a specific make, model and/or year, may be referred to as “type” of vehicle herein. Thus, the vehicle history database 30 has a plurality of vehicle history datasets related to a plurality of vehicles, each vehicle history dataset being related to a particular vehicle and having vehicle history attributes regarding the vehicle as described below.

As previously mentioned, vehicle history information system 12 may acquire vehicle history datasets from a variety of data providers. The vehicle history datasets from the vehicle history data suppliers which may be entered into vehicle history database 30 may be associated with a particular identification number and thus, a particular vehicle. The vehicle data forming the vehicle history datasets may be added as records to vehicle history database 30 and indexed by the identification number. Therefore, the vehicle history datasets stored in the vehicle history database 30 may include stored vehicle history attributes for a multitude of vehicles. The vehicle history datasets may be utilized by the vehicle history information system 12 in any manner. For example, the vehicle history datasets may be utilized by the vehicle history report module 35 to generate a report by retrieving and/or calculating vehicle history attributes associated with the requested identification number of a particular vehicle. Some examples of vehicle history attributes may include accident information, branded title information (such as salvage title), police accident report and damage disclosure information, mileage information (such as odometer problems and actual mileage listings), title/registration events (including government registration, taxi registration and commercial registration), stolen vehicle information, fleet information, emissions and safety inspection information, recall information, number of owners, and any other information relevant to the history of the vehicle.

Vehicle history database 30 may be database capable of effectively storing vehicle history datasets in an organized accessible manner to permit efficient easy access to desired pieces of data, e.g., one or more records associated with a particular identification number, using appropriate database management system software. Preferably, vehicle history database 30 may receive information from, and may be accessed by, various components of vehicle history information system 12.

In an exemplary embodiment, a correlation may exist between certain historical attributes of a vehicle and a risk associated with a vehicle financing transaction. When certain events appear in a vehicle's history as vehicle history attributes in predictable ways, that may indicate a level of risk associated with the vehicle financing transaction. These vehicle history attributes from a source such as vehicle history database 30 can be analyzed to lead to conclusions about the level of risk associated with financing the vehicle. They are referred to herein as “risk evaluation data variables” 28 and may be unique to each particular vehicle. This finding yields the advantageous property of embodiments which can make inferences and recommendations related to risk related to vehicle financing transaction based on the vehicle history in a database such as the vehicle history database 30. It is noted that the risk evaluation data variables 28 may include, for example, only a portion of all available vehicle history attributes in vehicle history database 30.

For example, a financing company may wish to take action based upon the knowledge that a vehicle has a recorded history which incorporates certain indicators that may indicate a level of risk involved in a vehicle financing transaction. First, they may wish to pursue further investigation into a vehicle financing transaction to evaluate a risk associated with the vehicle financing transaction. Second, they may determine that the risk of a default is too high to finance a purchase of a vehicle having a certain vehicle history, because that vehicle's history may suggest a high risk of default. The potential presence of risks associated with a particular vehicle, and the necessity to take action, may be directly determined based on values of the risk evaluation data variables 28 in vehicle history database 30. The use of the risk evaluation data variables 28, as disclosed herein, can provide information which allows inferences about a level of risk associated with a financing transaction, which can be useful in making decisions in evaluating a vehicle financing transaction.

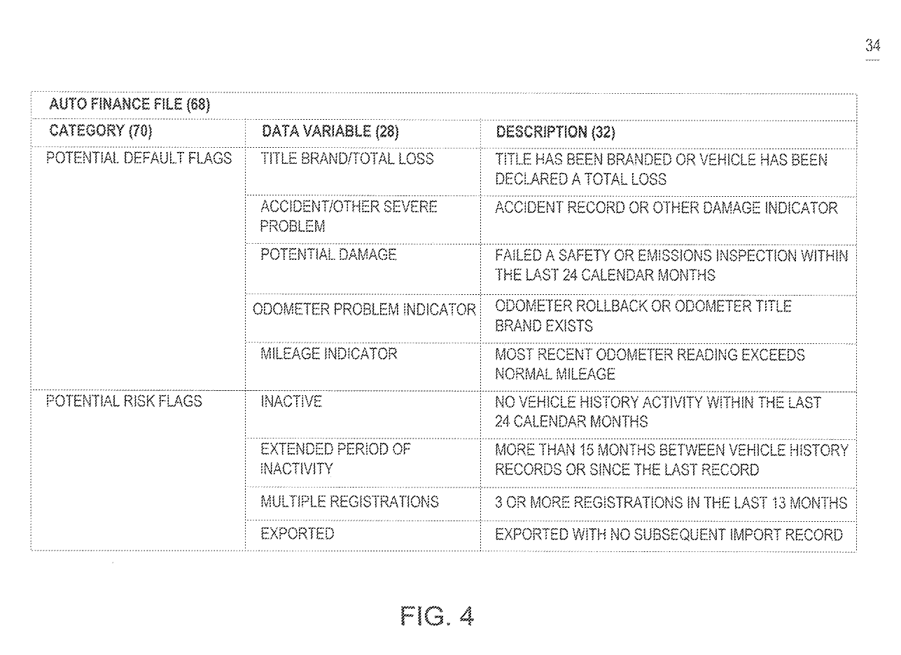

FIG. 4 shows a listing of numerous vehicle history data variables 28, discovered by Applicants to be risk evaluation data variables 28, that may be identified and stored in the vehicle history database 30 in datasets associated with a particular vehicle. For each risk evaluation data variable 28 listed in FIG. 4, a corresponding description 32 of that risk evaluation data variable 28 is also provided. A distinct inferences can be made from evaluating risk evaluation data variables 28 in a manner previously unknown in the prior art for determining the level of risk associated with financing of vehicles. These inferences further support Applicants' findings that for certain historical events of a particular vehicle, a default is likely to occur in a vehicle financing transaction.

These risk evaluation data variables 28, which Applicants have found to be relevant to the determination of risk of default may be categorized and organized in several ways, as shown in FIG. 4. First, there may be Potential Default Flags. These may include several variables. The first of these may be “Title Brand/Total Loss.” This variable may reflect that the vehicle's title has been branded or the vehicle has been declared a total loss. The second variable may be “Accident/Other Severe Problem.” This variable may reflect accident records or other similar damage indicators associated with a vehicle. The third flag may be “Potential Damage.” It may reflect that the vehicle failed a safety or emissions inspection within the last 24 calendar months or other relevant time period or damages to the vehicle. Fourth, “Odometer Problem Indicator” may reflect that odometer rollback or odometer title brand exists with regard to the vehicle's odometer. Fifth, “Mileage Indicator” may reflect the most recent odometer reading exceeds normal mileage.

Second, there may be Potential Risk Flags. First, “Inactive” may mean that there has been no vehicle history activity within a certain time period, such as the last 27 calendar months. Second, “Extended Period of Inactivity” may mean that it has been more than 15 months, or some other relevant time period, between vehicle history records or since the last record. Third, “Multiple Registrations” may mean that there were 3 or more registrations in a 13 month time period. Finally, “Exported” may stand for exported with no subsequent import record.

For example, these flags may represent aspects of a vehicle's history that can be determined or inferred by processing information stored in a vehicle history information vehicle history database 30, and which may reflect a heightened chance that a vehicle with that characteristic will be the subject of a higher risk that a vehicle with that characteristic will be subject to a higher risk of default during a financing transaction. Based upon Applicants' research, the identification of these factors as well as the computer-based information processing system and method which exploit these properties will allow accurate assessment of risk associated with a vehicle financing transaction.

Some of the above noted risk evaluation data variables 28 may be particularly likely to point to a likelihood of default and a risk of vehicle financing transaction in combination, while some of the risk evaluation data variables 28 may be less likely to create a suspicion of default or lower a risk of vehicle financing transaction in combination, depending on the selection of risk evaluation data variables 28 under consideration. For example, the risk of default associated with a vehicle financing transaction may be increased if there is a record that the vehicle was involved in an accident and has high mileage, because these two indicators together may point to the possibility that the vehicle has lost significant value and the borrower is more likely to default. Of course, the converse may be true in that the risk of default of a vehicle financing transaction related to a vehicle may be lowered if the vehicle has a more favorable combination of factors, such as involved in an accident and failed inspection during the same period of time, which would create a situation which would explain the failed inspection.

The risk evaluation data variables 28 may be retrieved, processed, displayed, and/or imported/exported to other databases or forwarded to other entities. For example, the risk evaluation data variables 28 retrieved and processed by the vehicle history report module 35 to create corresponding vehicle history reports for a particular VIN can be displayed by the user interface module 42. Thus, at least one risk evaluation data variable 28 may be utilized for determining a risk assessment of financing a vehicle. In another embodiment, a predetermined group of risk evaluation data variables 28 may be utilized for determining a risk assessment of financing a vehicle as discussed more fully herein below.

Moreover, once the risk evaluation data variables 28 have been assessed, the unique set of risk evaluation data variables 28 may be used to determine a down payment or an interest for financing a particular vehicle when a quote is requested, or to evaluate a vehicle financing transaction. It should be noted that some risk evaluation data variables 28 can be obtained directly from existing records, such as vehicle title records. However, some risk evaluation data variables 28 must be derived or inferred by processing information from existing vehicle records.

In another embodiment, similar risk evaluation data variables 28 that are similar may be grouped together, for example, similar in type values. By way of example, certain risk evaluation data variables 28 from vehicle history database 30 have been selected and categorized or grouped into the data groupings 34 shown in FIG. 4. Thus, in one disclosed embodiment, selected risk evaluation data variables 28 having common characteristics may be placed within certain data groupings 34. The selection or grouping of risk evaluation data variables 28 may also take into consideration the type of risk evaluation data variables 28 as outlined above. For example, all variables related to ownership may be grouped together. The risk evaluation data variables 28 can be stored separately in one embodiment in a database within a taxonomy.

The analysis of risk evaluation data variables 28 in the disclosed embodiment comprises at least two data groupings 34 for determining risk of vehicle financing transactions as disclosed herein. As shown, for example, in FIG. 4, data groupings 34 of default likelihood data variables may be classified as an Auto Finance File 68 or a Category 70. The aforementioned data groupings 34 are provided as one exemplary embodiment and should not be understood to limit the scope of the present disclosure. An Auto Finance File 68 may contain a set of risk evaluation data variables 28 in the vehicle history whose values for a given vehicle may be analyzed. Then, the history of a given vehicle demographic file 66 is compared to the Auto Finance File 68.

A Category 70 may contain the specific default likelihood factors which might potentially indicate default with respect to a vehicle financing transaction. These categories may facilitate a determination of a risk of default as disclosed herein and may also be used to make a determination about the quantitative likelihood of potential default, as disclosed below. In the preferred embodiment, the Category 70 may be a subset of the Auto Finance File 68, but this is not necessarily the case.

In an embodiment shown, a vehicle history data analysis unit 26 may include appropriate hardware (e.g., computer processor) and software for implementing the vehicle history report module 35, the condition determination module 36, and the user interface module 42, each module performing the functions as described in detail below. In this regard, vehicle history data analysis unit 26 may be implemented as a general purpose computing device with a central processing unit (CPU) or processor. The software for operating the vehicle history data analysis unit 26 and the various modules may reside in a non-transitory computer readable storage medium in the form of executable instructions that operate the vehicle history information system 12 and perform the functions and process steps described.

The vehicle history report module 35 may function to access vehicle history database 30 to retrieve appropriate vehicle history records associated, for example, with a particular VIN that is requested by a user of the vehicle history information system 12. For example, the user can be a vehicle financing company wishing to process a vehicle loan. In another example, the user may be a vehicle financing company wishing to assess the default risk of a portfolio of vehicle loans. Thus, the vehicle history report module 35 may include the appropriate software necessary to identify the appropriate vehicle history dataset from the vehicle history database 30, and to retrieve vehicle history data based on a particular request for example, a query limited to a particular VIN or plural VINs. The vehicle history report module 35 may further be adapted to arrange and organize the vehicle history data and information in a manner appropriate for further data processing and/or display as a vehicle history report via the user interface module 42 described below.

User interface module 42 may be adapted to generate a user interface or output for delivery to output device 24 of customer remote terminal 14. For example, the user interface module 42 may be adapted to generate information about a level of risk in a vehicle financing transaction for delivery to, and display by, output device 24 of customer remote terminal 14. Communications managing module 33 may be adapted to manage communications and interactions between vehicle history information system 12 and its various components, as well as with the various remote terminals 14 via the distributed network 16.

The condition determination module 36 of the vehicle history data analysis unit 26 may be adapted to provide a value of one or more risk evaluation data variables 28 for evaluation of risk associated with a vehicle financing transaction as listed, for example, in FIG. 4. The values for each risk evaluation data variable 28 may be indicators that the particular vehicle possesses or does not possess the characteristic of the particular risk evaluation data variable 28 that may indicate a particular risk, based on the real-world events in the vehicle's past that the vehicle history database 30 reflects. For example, if the vehicle history information indicates that the vehicle has or is likely to have a particular risk evaluation data variable 28 that may indicate default likelihood, such as that the vehicle has an odometer problem, then the value for the “Odometer Problem Indicator” data variable 28 may be a positive indication, for example, a “yes.” On the other hand, if the risk evaluation data variable 28 may not indicate that the vehicle has or is likely to have a particular risk evaluation data variable 28 that may indicate default likelihood, such as not having been exported, then the value for the “Exported” data variable 28 is a negative indication, for example, a “no.” Thus, for a particular risk evaluation data variable 28 that may indicate a default likelihood, a value of the aforementioned risk evaluation data variable 28 may be affirmed (e.g., via a “yes” indication) or denied (e.g., via a “no” indication), and determination of the likelihood of default may be based on the affirmation or denial of the value of the risk evaluation data variable 28 that may indicate a likelihood of default.

In other examples, the resulting information provided by evaluating the risk evaluation data variable 28 to determine a likelihood of default may not necessarily provide an indicator such as a positive or negative indicator, for example “yes” or “no,” respectively. For example, the “Exported” data variable 28 may allow one to assess a date indicating the date when the vehicle was exported. In this example, the aforementioned risk evaluation data variables 28 are associated with a date which may be evaluated and/or analyzed against other dates. For example, the question may be whether the value of the risk evaluation data variable 28 may exceed a threshold value or falls within a particular date range or proximity to other dates, such as the date of a vehicle finance request.

In another example, the values for each risk evaluation data variable 28 may be indicators that the particular vehicle possesses or does not possess the characteristic of the particular risk evaluation data variable 28 that may indicate a risk associated with financing a purchase of the particular vehicle, based on the real-world events in the vehicle's past that the vehicle history database 30 reflects. For example, if the vehicle history information indicates that the vehicle has or is likely to have a particular risk evaluation data variable 28 that may indicate a risk of financing the purchase of a vehicle, such as that the vehicle was in an accident, then the value for the “Accident/Other Severe Problem” data variable 28 may be a positive indication, for example, a “yes.” On the other hand, if the risk evaluation data variable 28 may not indicate that the vehicle has or is likely to have a particular risk evaluation data variable 28 that may indicate a risk associated with financing a purchase of a vehicle, such as not having been exported, then the value for the “Exported” data variable 28 is a negative indication, for example, a “no.” Thus, for a particular risk evaluation data variable 28 that may indicate a risk, a value of the aforementioned risk evaluation data variable 28 may be affirmed (e.g., via a “yes” indication) or denied (e.g., via a “no” indication), and determination of risk of a vehicle financing transaction may be based on the affirmation or denial of the value of the risk evaluation data variable 28 that may indicate a risk of a vehicle financing transaction. Such a determination may lead to further investigation or changes in various terms (e.g., duration, down payment, interest rate) of the vehicle financing transaction.

In other examples, the resulting information provided by evaluating the risk evaluation data variable 28 to determine a risk of a vehicle financing transaction may not necessarily provide an indicator such as a positive or negative indicator, for example “yes” or “no,” respectively. For example, the “Exported” data variable 28 may allow one to assess a date indicating the approximate time period when a vehicle was exported. In this example, the aforementioned risk evaluation data variables 28 are associated with a date which may be evaluated and/or analyzed against other dates. For example, the question may be whether the value of the risk evaluation data variable 28 exceeds a threshold value or falls within a particular date range or proximity to other dates, such as the date of a vehicle finance request.

Factors, such as “Inactive” may indicate heightened risk of default for a vehicle financing transaction as the factor that they indicate becomes increasingly disparate from the norm. Thus, for example, default is more likely to occur for vehicles where the last vehicle history activity date is more than 3 years previous relative to vehicles where the last activity date is only 1 year previous. In some embodiments, a risk evaluation data variable 28 that may indicate a likelihood of default which may be associated with a spectrum of circumstances may be analyzed so that a moderate risk of default is indicated when a marginal value of the risk evaluation data variable occurs and a heightened risk of default is indicated when a sharply disparate value of the risk evaluation data variable is present.

For certain data groupings 34, the condition determination module 36 of the vehicle history data analysis unit 26 may be adapted to provide an overall value of an entire data groupings 34. That is, if any one risk evaluation data variable 28 of a particular data grouping 34 has a positive indication, for example, a “yes,” then the overall value of the data grouping 34 is also positive or “yes.” However, it is noted that Boolean variables, true/false, 0/1, scales, or any other formulation of the variable that may reflect the data grouping 34 that can indicate when a default is more or less likely to occur can be used. For example, in reviewing the Auto Finance File 68, the flags may be grouped into two subgroupings, “Potential Default Flags,” and “Potential Risk Flags.” Within these subgroups, if any of the individual risk evaluation data variables 28 that indicate a cause for potential default may be likely to occur, it may indicate the subgrouping should be characterized to indicate that default may be likely to occur. Thresholds may be set so that several risk evaluation data variables 28 within a subgrouping or several concurrent subgroupings may raise cause for alarm before the system or method flags a problem. Thus, in this example, if the overall value is “yes,” then the determination is made that there is significant chance of default, and it may be necessary to investigate a financing transaction accordingly. Alternatively, if the overall value is “no,” then the determination is made that the vehicle history does not indicate any enhanced likelihood of default, in which case events can proceed as they would have without investigation. Thus, determination of whether there is a potential for default of a vehicle financing transaction is based on some combination of respective overall values of the data groupings 34. For example, if the majority or all of the overall values of the data groupings 34 are in the affirmative, e.g., “yes,” or negative, e.g., “no,” then that determination and appropriate attendant subsequent action should be appropriately made based on this result. Note that as an alternative, the user may specify how the risk evaluation data variables 28 are to be grouped into the data groupings 34.

Thus, the information, i.e., overall value provided by an analysis of the risk evaluation data groupings 34, can facilitate a determination of a risk of a vehicle financing transaction as disclosed herein. This, at least, is due to the correlation of the risk evaluation data variables 28 listed in the data grouping 34 in various combinations, with an empirical incidence of default associated with vehicles possessing those variables in their histories. The formed data groupings 34 may provide information previously unknown in the art for determining a risk associated with a vehicle financing transaction, since the data grouping 34 may be specifically packaged to provide specific vehicle history information regarding default which may indicate when further investigation into a vehicle financing transaction may be warranted.

While the present disclosure may describe the use of data groupings 34 that comprised of risk evaluation data variables 28, it is noted that the risk evaluation data variables 28 have separate utility apart from being grouped into the aforementioned data groupings 34. The value of the risk evaluation data variables 28 can be reviewed, for example, by a financing company (or other entities), and used as a basis for initiating risk analysis, adjusting terms, and setting payments, at a minimum, as described herein. This may include a scenario in which the value of one risk evaluation data variable 28 may be evaluated and a decision to start a risk analysis, adjusting terms, and setting payments may occur based on this value. In another scenario, the values of a plurality of risk evaluation data variables 28, whether similar or not, may be evaluated and underwriting and rating may occur based upon the results, e.g., any one value exists, a majority of the values exist, or a combination of the values exist or do not exist.

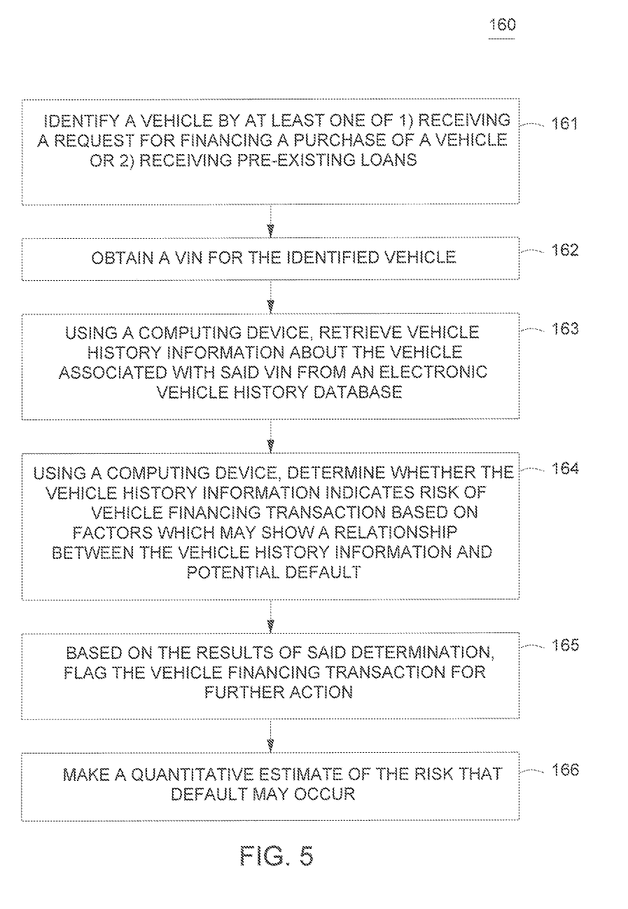

Thus, as shown in FIG. 5, a computer-implemented method which an exemplary embodiment of the present disclosure executes may involve first, to identify a vehicle by at least one of 1) receiving a request for financing a purchase of a vehicle, 2) receiving a pre-existing loan (step 161). This identifying step may be done either automatically in accordance with predefined rules and/or procedures or by involving a selection by the user. The next step is to obtain a VIN for the identified vehicle (step 162). Third, the method may include using a computing device, retrieving vehicle history information from an electronic vehicle history database 30 of the vehicle associated with the VIN (step 163). Fourth, the method may include using a computing device, determining whether the vehicle history information indicates risks of the vehicle financing transaction based on factors which may show a relationship between the vehicle history information and potential default related to the vehicle financing transaction (step 164). Fifth, the method may include, based on the results of the determination, flagging the vehicle financing transaction of potential default for further action (step 165).

Thus, in FIG. 5, the VINs may identify vehicles (steps 161-162) which allows the method to associate risk evaluation data variables 28 (step 163) with the one or more submitted VINS. Each risk evaluation data variable 28 may indicate a warning to the financing company based on whether the vehicle history record for that particular vehicle possesses or does not possess the characteristic of the particular risk evaluation data variable 28. However, the system and method may also record additional information related to the risk evaluation data variable 28. For example, if there has been an “Extended Period of Inactivity” (e.g., more than 27 months between vehicle history records or since the last record), the system and method may also store, for example, the specific period of inactivity. The risk evaluation data variables 28 may further be combined into pre-selected data groupings 34 as previously discussed. Based upon a value of the respective risk evaluation data variables 28 or the overall value of the respective data groupings 34, determination of whether default is likely (step 165) to occur based on the values of the risk evaluation data variables 28 or the overall values of the one or more data groupings 34. Furthermore, if the determination is made that default is likely, a quantitative estimate of the risk that default may occur (step 166) based upon information associated with the risk evaluation data variables 28, such as the value of one or more data variables, the overall value of one or more groups of data variables, or a value of a score based on one or more risk evaluation data variables 28 as discussed herein below. In another embodiment, the information associated with the risk evaluation data variables 28 may be used only for providing an estimate of the likelihood that default may occur.

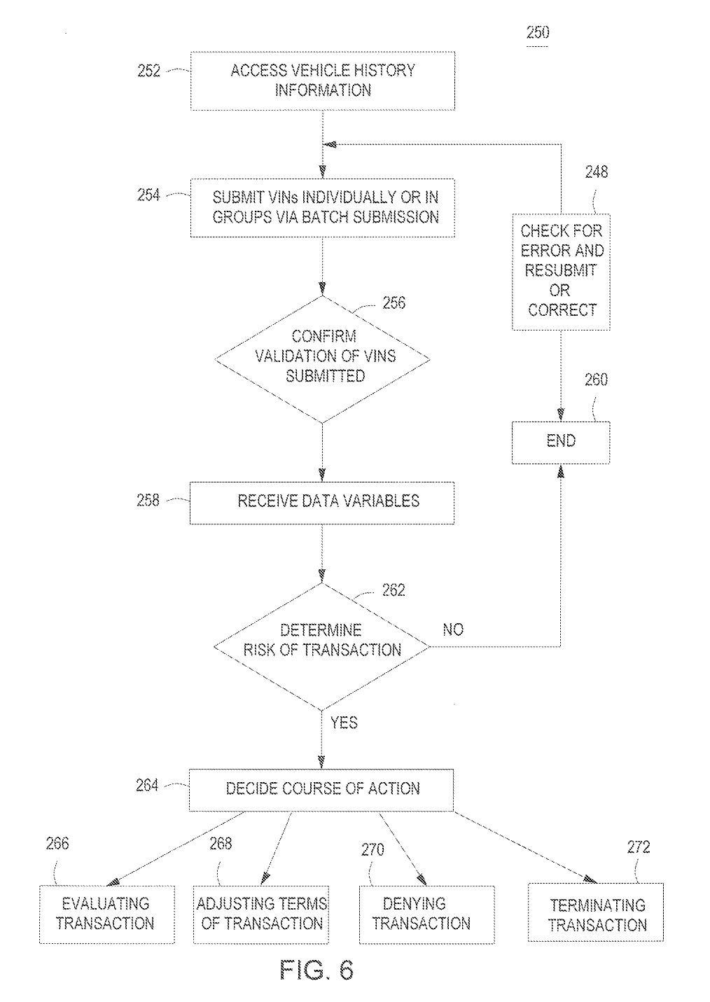

Turning to FIG. 6, an example of determination of a risk associated with a vehicle financing transaction based on vehicle history according to an embodiment of the present disclosure. A financing company (or another individual or financial entity who has reason to want to assess a risk associated with a vehicle financing transaction) may be granted access to the vehicle history information (step 252) provided, for example, by a vehicle history provider. Note that the embodiments operate when a potential financing transaction is under consideration as to whether the financing transaction is too risky. In one embodiment, a vehicle history provider may maintain the vehicle history information system 12 (FIGS. 1 and 2) and may be capable of providing a plurality of risk evaluation data variables 28, and/or grouping data variables 28 to create a plurality of data groupings 34, according to preferences of the financing company or other user. The user may determine and requests which data groupings 34 will be provided from the vehicle history provider for an agreed transaction price. In one example, the aforementioned transaction price may be based upon a number of VIN numbers submitted to the vehicle history provider by the user.

Thus, the financing company may submit the VINS (step 254), for example, individually or in a batch submission, to the vehicle history provider. In another example, the financing company may submit a portfolio of VINS to the vehicle history provider. The vehicle history provider may be coupled to the distributed network 16 (FIGS. 1 and 2) to receive and forward the VINS submitted by the financing company to the vehicle history information system 12 (FIGS. 1 and 2). Alternatively, vehicle history provider may allow the financing company to submit the VINS directly to the vehicle history information system 12.

The VINS may be validated (step 256) and the process may continue. In one embodiment, the validation process may include receiving information to confirm the vehicle of interest. For example, FIG. 3 depicts a “Demographic File” 66 which may provide an exemplary array of information or vehicle identification data 29. The Demographic File 66 may be helpful in confirming that the requested information for the submitted one or more VINS are indeed attributed to the correct vehicles. Thus, the description 37 of each vehicle identification data 29 may further facilitate confirmation of one or more preferred vehicles. In an instance wherein the VINS are not confirmed, the VINS may be checked for accuracy and resubmitted for processing (step 248). Alternatively, the process may end (step 260).

Upon confirmation of the VINS (step 256), risk evaluation data variables 28 may be collected from a larger set of vehicle attributes in the vehicle history database 30 associated with each vehicle and forwarded to the vehicle history data analysis unit 26 (step 258). In an example, the risk evaluation data variables 28 may be organized into the data groupings 34. Upon receiving the risk evaluation data variables 28 and data groupings 34, the vehicle history data analysis unit 26 may proceed with the analysis of the information, which may include determining relationships between the various parts of the data to provide a unified indication as to a risk associated with a vehicle financing transaction (step 262). The financing company may then use this recommendation associated with the received risk evaluation data variable 28 and data grouping 34 information to select a course of action (step 264). For example, the action may include further evaluation the vehicle financing transaction (step 266) or adjusting terms of the vehicle financing transaction (step 268) or deny the vehicle financing transaction (step 270) or terminating the vehicle financing transaction and repossess the vehicle (step 272).

In a particular embodiment, an analysis of risk evaluation data variables 28 selected, for example, from the vehicle history database 30 may be performed in which the risk evaluation data variables 28 may be utilized to generate a scoring result, i.e., a score or a categorization. Thus, the score or categorization may be used to assess how likely default is to occur. Importantly, the score may also facilitate using the results of the risk evaluation analysis to determine a length of a loan, an amount of down payment, an interest rate, restrictions and other terms associated with the vehicle financing transaction. The score may include a numerical value, for example, indicative of a value for an interest rate or a down payment or a loan period for a potential customer. However, the score may also be expressed in any other form that may permit the indication of whether default is likely to occur during a term of a loan. The score may be used to generate an overall default likelihood attributed to an assessment of risk for a prospective financing consumer. The decisions about how to handle the actions taken based on the default likelihood processing and the scoring process itself may be based on the same integrated criteria or rules or may be based on separate criteria or rules.

Thus, in one example, the financing company may supply one or more VINS to the vehicle history provider. Risk evaluation data variables 28 may be generated, for example, in accordance with a predetermined rules or conditions. One or more of the risk evaluation data variables 28 may be processed and transformed into an output. The output may be characterized as a score, which may include a numerical value, mark, symbol, color, and/or any other suitable representation for generating an output. Hence, in one embodiment, the score may include a single numerical value indicative of an analysis result of the risk evaluation data variables 28 being fed within and processed by the algorithm. Furthermore, each of the risk evaluation data variables 28 fed to the algorithm may be suitably weighted according to a user preference, which may be guided by empirical knowledge about the importance of various factors or by other motivations. Thus, in one embodiment, certain risk evaluation data variables 28 may be weighted more than others, because a user may be interested in particular trends or characteristics of some risk evaluation data variables 28 more than others. For example, as a user, e.g., a financing company, may prefer that certain risk evaluation data variables 28 have a greater impact on determining a risk of default than other risk evaluation data variables 28. An example of this would be that a user might want to emphasize odometer-related data, accident or title information, because they have information related to that particular vehicle or classes of vehicles that such data would be particularly helpful. Therefore, in an embodiment, risk analysis, that is, determining whether there is a higher likelihood of default and/or how high that likelihood is, may not be based on any one value or any one overall value but a weighted combination, i.e., algorithmic or mathematical model or equation.

The transformation algorithm may be embodied in a software program appropriately configured to rim the algorithm on a computer and produce the output described hereinabove. In an embodiment, the software program may run as a series of modules executed on appropriate computing hardware, or alternatively may consist of a set of non-transitory computer-readable media with instructions which when executed by a computer processor implement the functions. The algorithm may be adaptable for receiving inputted data such as the risk evaluation data variables 28. Thus, in one embodiment, data, such as risk evaluation data variables 28, may be inputted via the software program into the algorithm whereupon the software program executes the algorithm to produce an output such as the disclosed score or categorization. In operation, an entity, such as the vehicle history provider, may provide a service to a client, such as a financing company. The service may include running the algorithm and providing a score or categorization to the financing company. Alternatively, the algorithm may be run directly by a party desiring an output of the algorithm (e.g., the score or categorization as disclosed herein).

Hence, in accordance with one embodiment, an algorithm may be provided as follows: [X]A+[Y]B . . . +[Z]C=SCORE, wherein X, Y, and Z are weight factors and A, B, and C are data variables 28 selected from the vehicle history database 30. Thus, in one exemplary application, the following formula based on the disclosed algorithm model is provided as: (A*125)+(B*50)+(C*20)=SCORE, where A is the value of the title brand data variable, B is the value of the odometer problem data variable, and C is the value of the extended period inactivity data variable; and wherein:
If the vehicle has a title brand, then A=1.
If the vehicle does not have a title brand, then A=0.
If the vehicle has an odometer problem, then B=1.
If the vehicle does not have an odometer problem, then B=0.
If the extended period of inactivity is past a certain threshold, for example 15 months, then C=1.
If the extended period of inactivity is not past a certain threshold, for example 15 months, then C=0.

In an example, the value of risk evaluation data variable A, directed to whether the vehicle has a title brand, is weighted more heavily than the value of risk evaluation data variables B and C, directed to odometer problem and extended period of inactivity, respectively.

Likewise, the value of risk evaluation data variable B is weighted more heavily than the value of risk evaluation data variable C. The higher weighted risk evaluation data variable may be given a higher impact on the risk score than a lower weighted risk evaluation data variable. Of course, in an embodiment using data groupings 34, data variables A, B, and C (in the above example) may represent overall values of data groupings 34.

In another example, a vehicle financing transaction may be associated with financing a 2009 Toyota Camry LE for a period of five years and the vehicle is 3 years old. An algorithm may be applied having an accident data variable, a mileage data variable, a number of owners data variable to determine a score associated with the vehicle financing transaction. For example, the accident variable may include a positive indication (e.g., 1 as discussed above) because the vehicle was involved in a severe accident with frame damage and airbag deployment. The mileage data variable may include a positive indication (e.g., 1 as discussed above) because the vehicle has high mileage of 60,000 miles based on the average miles (e.g., 20,000 miles) driven per year. The number of owners data variable may include an indication of number of owners (e.g., 4 owners). Also, the accident variable may be assigned a weight of 125, the mileage data variable may be assigned a weight of 75 and the number of owners data variable may be assigned a weight of 25. As illustrated in this exemplary embodiment, the accident variable may be weighted more than the mileage data variable and the number of owners data variable because the accident variable is more directly correlated with the risk of default for the vehicle financing transaction. The algorithm may determine that the score for the vehicle financing transaction to be 300 (e.g., 125*(1)+75*(1)+25*(4)). The higher score may indicate that there is a higher risk of default associated with the vehicle financing transaction because of the negative vehicle history.

In another example, a vehicle financing transaction may be associated with financing a 2010 Ford Fusion SE for a period of five years and the vehicle is 2 years old. An algorithm may be applied having an accident data variable, a mileage data variable, a number of owners data variable to determine a score associated with the vehicle financing transaction. For example, the accident variable may include a negative indication (e.g., 0 as discussed above) because the vehicle has been not involved in an accident. The mileage data variable may include a negative indication (e.g., 0 as discussed above) because the vehicle has low mileage of 14,000 miles based on the average miles (e.g., 7,000 miles) driven per year. The number of owners data variable may include an indication of number of owners (e.g., 1 owner). Also, the accident variable may be assigned a weight of 125, the mileage data variable may be assigned a weight of 75 and the number of owners data variable may be assigned a weight of 25. As illustrated in this exemplary embodiment, the accident variable may be weighted more than the mileage data variable and the number of owners data variable because the accident variable is more directly correlated with the risk of default for the vehicle financing transaction. The algorithm may determine that the score for the vehicle financing transaction to be 25 (e.g., 125*(0)+75*(0)+25*(1)). The low score may indicate that there is a lower risk of default associated with the vehicle financing transaction because of the positive vehicle history.

In other examples, a financing company may evaluate a portfolio of vehicle financing transactions. For example, the risk evaluation of a portfolio of vehicle financing transactions may be based at least in part on a vehicle history of each individual vehicle identified by the VINs and thus may allow more accurate risk evaluation of the portfolio of vehicle financing transactions. In an exemplary embodiment, a portfolio of vehicle financing transactions may include a plurality of vehicles having different vehicle history information. The portfolio of vehicle financing transactions may include a first vehicle of 2010 Toyota Camry LE having 31K miles that has was owned by 4 owners and had a major accident with airbag deployment. A second vehicle of 2010 Toyota Camry LE having 59K miles that has been owned by 1 owner and no accidents. A third vehicle of 2010 Toyota Camry LE having 44K miles that has been owned by 3 owners and a branded title. A fourth vehicle of 2010 Toyota Camry LE having 28K miles that has been owned by 4 owners and had a major accident with frame damage. The accident variable may be assigned a weight of 125, the mileage data variable may be assigned a weight of 75 and the number of owners data variable may be assigned a weight of 25. As illustrated in this exemplary embodiment, the accident variable may be weighted more than the mileage data variable and the number of owners data variable because the accident variable is more directly correlated with the risk of default for the vehicle financing transaction. The algorithm may determine that the score for each of vehicles in the portfolio of vehicle financing transactions to be 200, 100, 175 and 200, respectively for the four vehicles (e.g., 125*(A)+75*(B)+25*(C)). To determine the overall risk of the portfolio by averaging the score of each vehicle financing transaction. The portfolio of vehicle financing transaction may have an average risk score of 169. The high average risk score may indicate that the portfolio of vehicle financing transaction may be of high risk default.

Note further that an embodiment may be possible where an algorithm may be used where data variables A, B, and C (or whichever variables are used) may assume values other than 1 and 0. For example, the risk evaluation data variables 28 may take on the value of the specific number of accidents the vehicle is involved, to reflect the high risk of a default. A scaling formula may be used to combine information related to such a data variable and incorporate it into the algorithm.

In the previous example, the score may be represented as a numerical value. Thus, a decision to investigate further, to determine terms of a vehicle financing transaction, or to make an adjustment to an existing loan may rely on whether the score falls into a numerical range. For example, if the available scoring range is from 0-100, then it may be determined that scores from 70-100 indicate that a further investigation is warranted and thus a score below 70 will indicate that no further investigation is warranted. Similarly, a score above 70 may indicate that a quote or adjustment of terms of a vehicle financing transaction will be employed by the financing company. Furthermore, the same numerical result of the score may be utilized to determine calculations related to financing transactions related to the vehicle in order to set a down payment, interest rate, length of the transaction and other terms of the financing transaction. For example, if the score falls in a range of 70-80, then the down payment, interest rate and length of transaction is set at a first amount. Similarly, if the score falls in a range of 80-90, then the down payment, interest rate and length of transaction is set at a second amount different (e.g., higher) than the first dollar amount. Likewise, if the score falls in a range of 90-100, then the down payment, interest rate and length of transaction is set at a third amount different (e.g., higher) than the first and second amounts. Alternatively, the rating procedure can be based on a separate algorithm or rule and/or a separate score, with respect to the underwriting procedures.

As discussed above, the output, i.e., score or categorization, of the algorithm may be useful in a variety of applications for assessing risk of default and assessing risk of a loan. For example, if the score or categorization is represented as a color, such as green, or a mark such as “+,” or word such as “go,” then the indication of green, or “+” or “go” may mean that it is advisable to proceed without further investigation, or that it is advisable to provide a favorable financing terms or term adjustments. In another example, if the score is represented as a color, such as red, or a mark such as “−,” or a word such as “stop,” then the indication of red, or “−,” or “stop” may mean that further investigation or evaluation is advisable, or that it is necessary to modify the financing quote or term adjustments adversely. In other examples, a financing company may decide to deny financing transactions or terminate existing financing transactions if a negative indication occurs.

Also, the score may be used to determine terms of a vehicle financing transaction. Such determination of terms may be proportional to the score. For example, having calculated a score or categorization in accordance with the algorithm above, wherein the score is a numerical value, a calculated interest rate (IR) may be determined as follows:

IR=CI*SCORE/K

wherein CI is a computed interest rate based upon non-vehicle history data variables or an existing interest rate and K is a scaling factor appropriate to the range of scores. The variable “CI” may be based upon criteria utilized in typical calculations for determining an interest rate, such as a base interest rate offered by a financing company. Thus, the value “IP,” according to the disclosed embodiment, provides a modified or “new” interest rate which otherwise may generate an updated interest rate based upon the disclosed score.

In another example, having calculated a score or categorization in accordance with the algorithm above, wherein the score is a numerical value, a calculated down payment (DP) may be determined as follows:

DP=CDP*SCORE/K

wherein CDP is a computed down payment based upon non-vehicle history data variables or an existing down payment and K is a scaling factor appropriate to the range of scores. The variable “CDP” may be based upon criteria utilized in typical calculations for determining a down payment, such as a base down payment offered by a financing company. Thus, the value “DP,” according to the disclosed embodiment, provides a modified or “new” down payment which otherwise may generate an updated down payment based upon the disclosed score.

Hence, an embodiment of the use of the algorithm incorporating risk evaluation data variables 28 has been shown. It has been further shown that the risk evaluation data variables 28 may also be manipulated, such as being weighed against one or more risk evaluation data variables 28 within the algorithm, in order to evaluate a risk of a vehicle financing transaction as deemed appropriate.

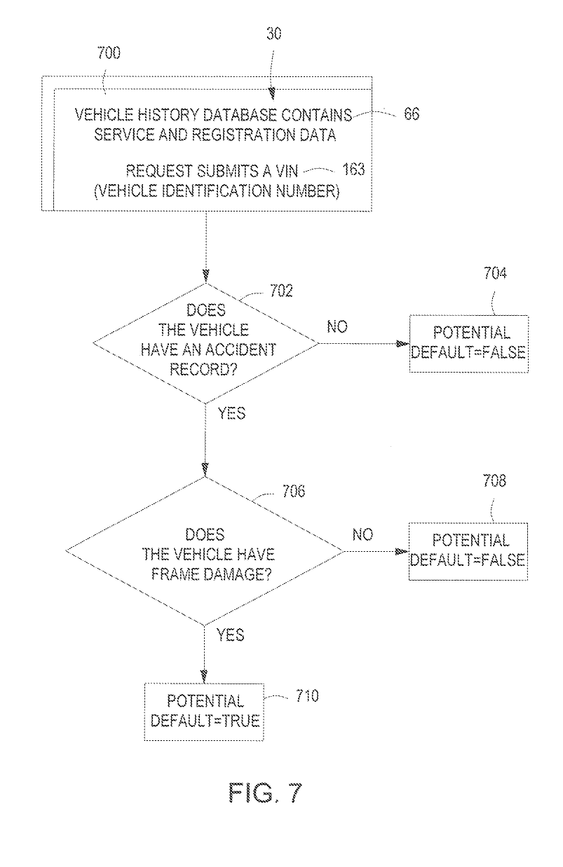

FIGS. 7-16 illustrate ten specific decision processes by which the determining step 164 may be implemented. These are illustrative examples, and should serve to show how versatile the principles developed in these embodiments in fact are without placing any undue constraints on the scope of the claims. The “answers” to the “questions” in the examples are determined by programmed logic in the vehicle history information system 12 examining data in records of vehicle history database 30.

### EXAMPLE I

### FIG. 7

In FIG. 7, at 700, the background of the determining step 164 may be the vehicle history database 30 that may contain vehicle history data variables 28, and the request submits a VIN 163. The logic of the embodiments proceeds through a decision process, asking “Does the vehicle have an accident record?” 702. If no, then potential default=false 704. However, if yes, then it is asked, “Does the vehicle have frame damage?” 706. If no, then potential default=false 708. However, if yes, then potential default=true 710. This is based on the assumption information that may come from a service provider such as CARFAX™ that may maintain an ownership database based upon public and private data sources, and that the service provider such as CARFAX™ may employ a number of calculations to determine if frame damage exists.

Thus, the determining step may comprise determining if there is an indication that a vehicle has been in an accident and has frame damage. If both are true, i.e. yes, then the determining step may determine that there is a higher risk for default in a vehicle financing transaction because the value of the vehicle is less than comparable vehicle and the vehicle may be prone to malfunction.

### EXAMPLE II

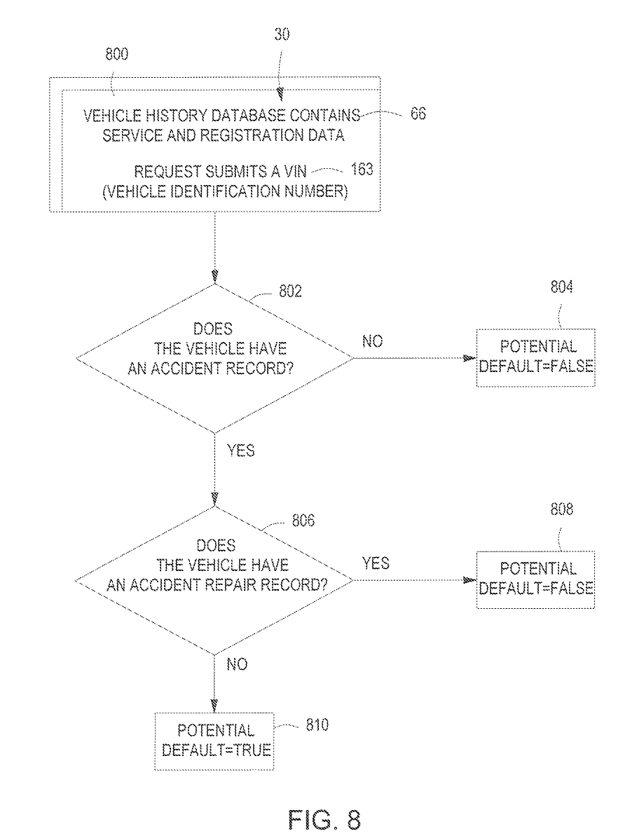

### FIG. 8

In FIG. 8, at 800, the background of the determining step 164 is that the vehicle history database 30 may contain vehicle history data variables 28, and the request submits a VIN 163. The logic of the embodiments proceeds through a decision process, asking “Does the vehicle have an accident record?” 802. If no, then potential default=false 804. However, if yes, then it is asked, “Does the vehicle have an accident repair record?” 806. If yes, then potential default=false 808. However, if no, then potential default=true 810. This is based on the assumption the vehicle history service provider, such as CARFAX™ may maintain an ownership database based upon public and private data sources, and that the data service provider such as CARFAX™ may employ logic to determine if the repair record relates to the accident record.

Thus, the determining step may comprise determining if a vehicle has been in an accident and if the damage to the vehicle has been repaired. If the accident record is true, i.e. Yes, and the repair record is false, i.e., No, then the determining step determines that there is a higher risk of default because the value of the vehicle is less than comparable vehicles and the vehicle may be prone to malfunction.

### EXAMPLE III

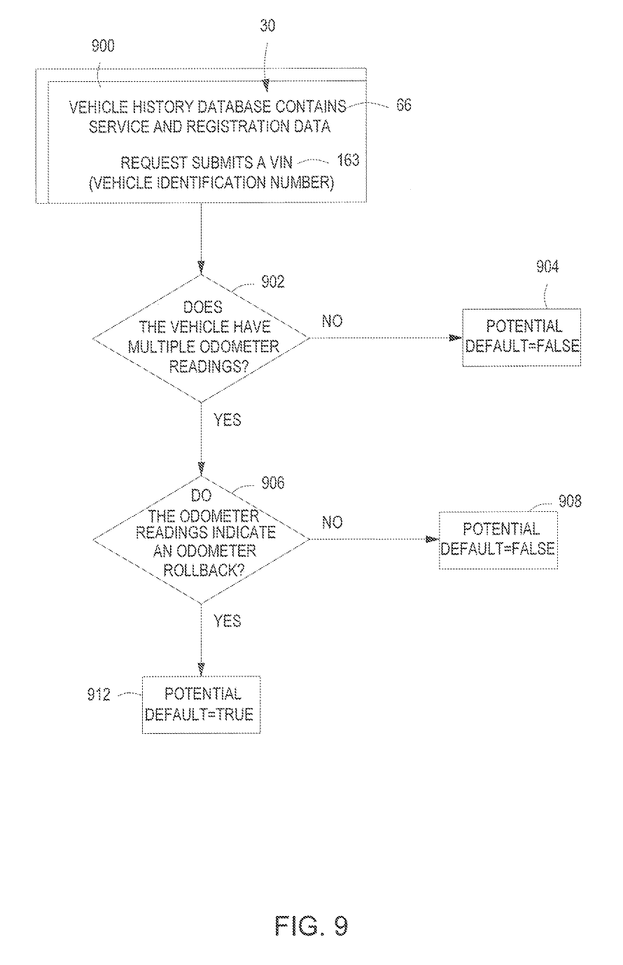

### FIG. 9

In FIG. 9, at 900, the background of the determining step 164 is that the vehicle history database 30 may contain vehicle history data variables 28, and the request submits a VIN 163. The logic of the embodiments proceeds through a decision process, asking “Does the vehicle have multiple odometer readings?” 902. If no, then potential default=false 904. However, if yes, then it is asked, “Do the odometer readings indicate an odometer rollback?” 906. If no, then potential default=false 908. However, if yes, then potential default=true 912. This is based on the assumption the vehicle history provider, such as CARFAX™, may store odometer readings from a large number of public and private data sources, and that the service provider such as CARFAX™ may employ logic to determine if the odometer readings indicate that the odometer has been rolled back.

Thus, the determining step may comprise determining if there are sufficient odometer readings and if those readings indicate an odometer rollback. Thus, if odometer rollback is yes, then the determining step may determine that there is a higher risk of default because the value of the vehicle is less than comparable vehicles and the vehicle may be prone to malfunction.

### EXAMPLE IV

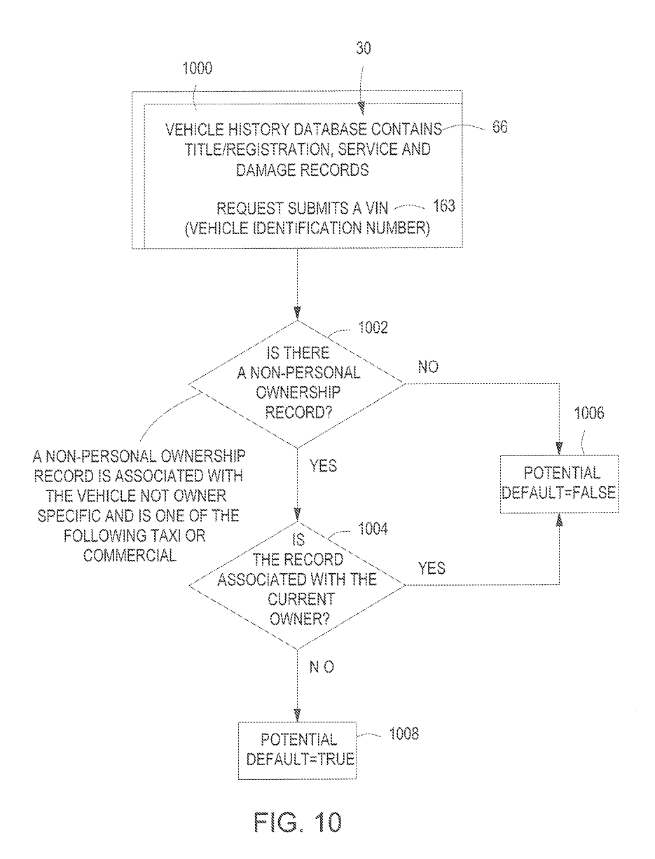

### FIG. 10

In FIG. 10, at 1000, the background of the determining step 164 is that the vehicle history database 30 may contain title/registration data variables 28, service and damage data variables 28, and the request submits a VIN 163. The logic of the embodiments may proceed through a decision process, asking “Is there a non-personal ownership record?” 1002. If no, then potential default=false 1006. However, if yes, then it is asked, “Is the record associated with the current owner?” 1004. If yes, then potential default=false 1006. However, if no, then potential default=true 1008. In this context, a non-personal ownership record indicates that a vehicle is used for uses other than personal use (e.g., Taxi or Commercial). Here, a taxi is defined as a vehicle primarily used to convey passengers for a fee, and not for personal use, and a commercial vehicle is a vehicle used for commercial purposes, such as a limousine, or hauling truck.

Thus, the determining step may comprise determining if there is an indication that there is a non-personal ownership record and the record is associated with the current owner. If non-personal owner is true, i.e. yes, and the current owner is false, i.e., no, then the determining step determines that there is a higher risk of default because vehicle is likely to have sustained greater wear and tear than comparable vehicles.

### EXAMPLE V

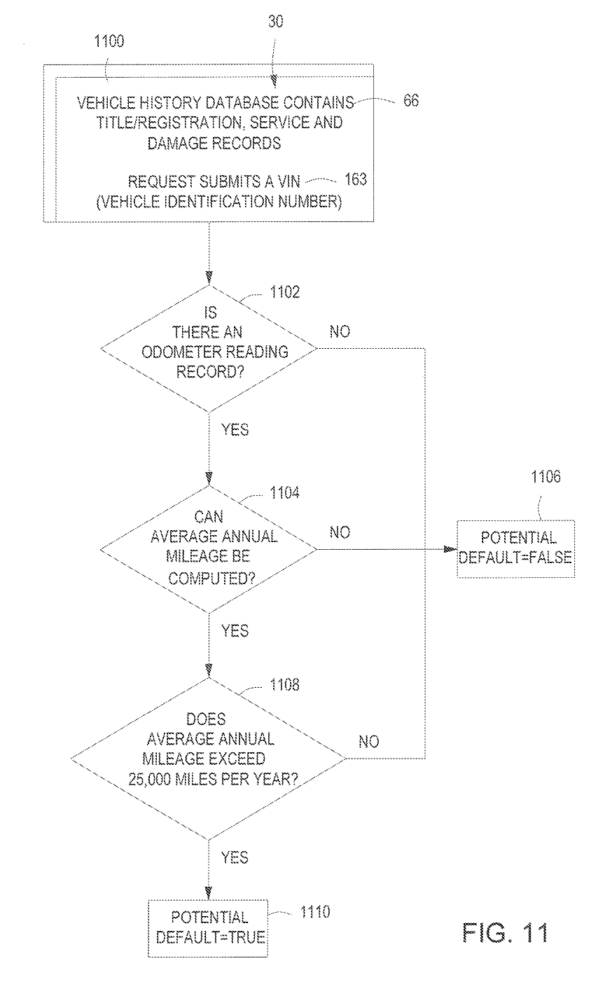

### FIG. 11

In FIG. 11, at 1100, the background of the determining step 164 may be that the vehicle history database 30 may contain title/registration data variables, service and damage data variables, and the request submits a VIN 163. The logic of the embodiments may proceed through a decision process, asking “Is there an odometer reading record?” 1102. If no, then potential default=false 1106. However, if yes, then it is asked, “Can average annual mileage be computed?” 1104. If no, then potential default=false 1106. However, if yes, then it is asked “Does average annual mileage exceed 25,000 miles per year?” 1108. If no, then potential default=false 1106. If yes, then potential default=true 1110. This is based on the assumption that the vehicle history provider, such as CARFAX™, may store odometer readings from a large number of public and private data sources, and that the service provider such as CARFAX™ may employ a number of calculations to determine average annual mileage. This resulting mileage is then compared to a benchmark, e.g. 25,000 miles per year, to determine if the variable is true or false.

Thus, the determining step may comprise determining if there are sufficient odometer readings to compute average annual mileage and if the resulting average annual mileage exceeds 25,000 miles per year. If both are true, i.e. yes, then the determining step determines that there is a higher risk of default because the vehicle is likely to have sustained greater wear and tear than comparable vehicles.

### EXAMPLE VI

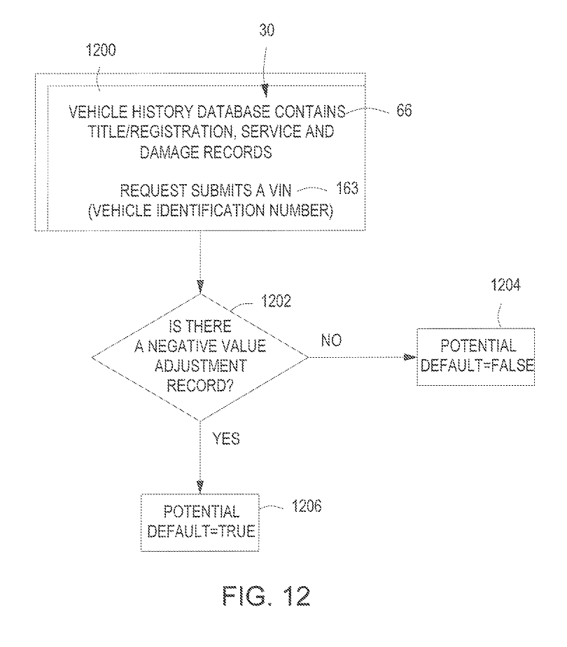

### FIG. 12

In FIG. 12, at 1200, the background of the determining step 164 is that the vehicle history database 30 may contain title/registration data variables, service and damage data variables, and the request submits a VIN 163. The logic of the embodiments proceeds through a decision process, asking “Is there a negative value adjustment record?” 1202. If no, then potential default=false 1204. However, if yes, then potential default=true 1206. This is based on the assumption that a valid value adjustment record is associated with the vehicle, not owner specific and is one of the following: Title Brand, Accident, Failed Inspection, Odometer Problem, or High Mileage related to the industry standard. A title brand may occur when a title is updated per state regulations indicating a damage condition. Accident may be when the vehicle history service provider (e.g., CARFAX™) has received information that an accident has occurred. Failed inspections may mean that a state safety or emission inspection has been performed and the vehicle has failed the inspection. With the odometer problem, the vehicle history service provider has determined that an actual or potential problem may exist with the odometer. High mileage may mean that the mileage on the vehicle in question exceeds normal mileage.

Thus, the determining step may comprise determining if there is a negative value adjustment record. If the negative value adjustment is true, i.e. yes, then the determining step may determine that there is a higher risk of default because of the negative value adjustment.

### EXAMPLE VII

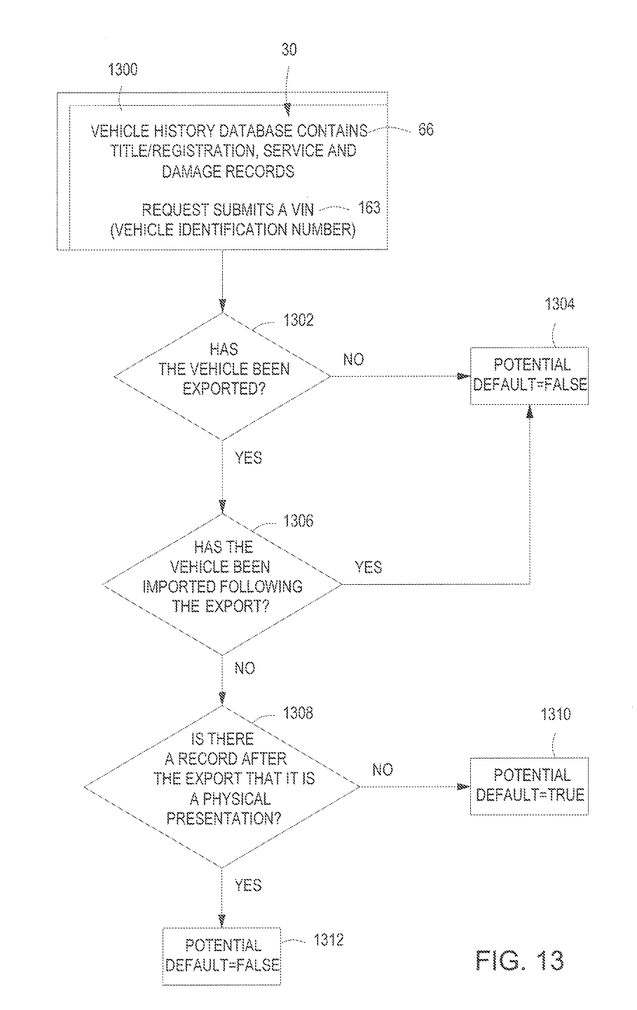

### FIG. 13

In FIG. 13, at 1300, the background of the determining step 164 may be that the vehicle history database 30 may contains title/registration data variables, service and damage data variables, and the request submits a VIN 163. The logic of the embodiments may proceed through a decision process, asking “Has the vehicle been exported?” 1302. If no, then potential default=false 1304. However, if yes, then it is asked, “Has the vehicle been imported following the export?” 1306. If yes, then potential default=false 1304. However, if no, then it is asked “Is there a record after the export that it is a physical presentation?” 1308. If no, then potential default=true 1310. If yes, then potential default=false 1312. This may be based on the definitions that exports are vehicles that have been sent outside the United States and imports are vehicles that have been brought into the United States. In this context, physically presented may indicate that the vehicle history service provider has received a recent record that the vehicle has been verified as a physical vehicle by a reputable source.

Thus, the determining step may comprise determining if there is an indication that the vehicle has been exported and the vehicle has not been imported following the export and there is no record after the export that is a physical presentation. If exported is true and both physically presented and imported are false, then the determining step may determine that there is a higher risk of default because the vehicle has been exported and the vehicle financing transaction may be fraudulent.

### EXAMPLE VIII

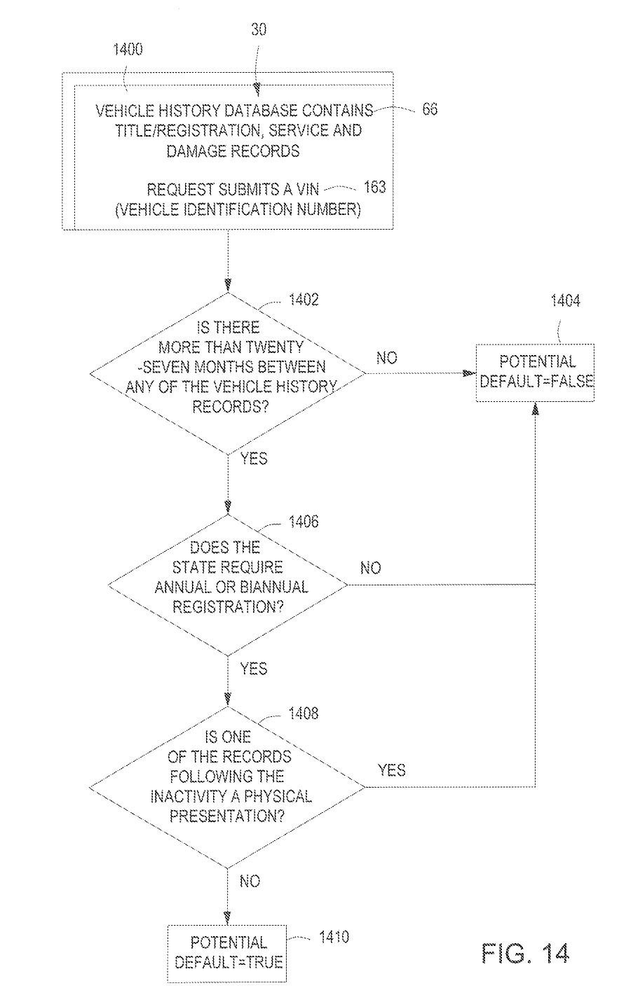

### FIG. 14

In FIG. 14, at 1400, the background of the determining step 164 may be that the vehicle history database 30 may contain title/registration data variable, service and damage data variables, and the request submits a VIN 163. The logic of the embodiment may proceed through a decision process, asking “Is there more than twenty-seven months between any of the vehicle history records?” 1402. If no, then potential default=false 1404. However, if yes, then it is asked, “Does the state require annual or biannual registration?” 1406. If no, then potential default=false 1404. However, if yes, then it is asked “Is one of the records following the inactivity a physical presentation?” 1408. If no, then potential default=true 1410. If yes, then potential default=false 1404. This may be based on the definitions that physically presented indicates that the vehicle history service provider has received a recent record that the vehicle has been verified as a vehicle by a reputable source.

Thus, the determining step may comprise determining if there are a combination of an indication that there is more than 27 months between any of the vehicle history records, an indication that the state requires annual or biannual registration, and an indication that none of the records following the inactivity is a physical presentation, thus leads to a flagging of potential default. If both 27 months between records and annual/biannual registration are true, i.e. yes, and one of the subsequent records is not a physical presentation, i.e. no, then the determining step may determine that there is higher risk of default because the vehicle's VIN has been cloned and the vehicle financing transaction may be fraudulent.

### EXAMPLE IX

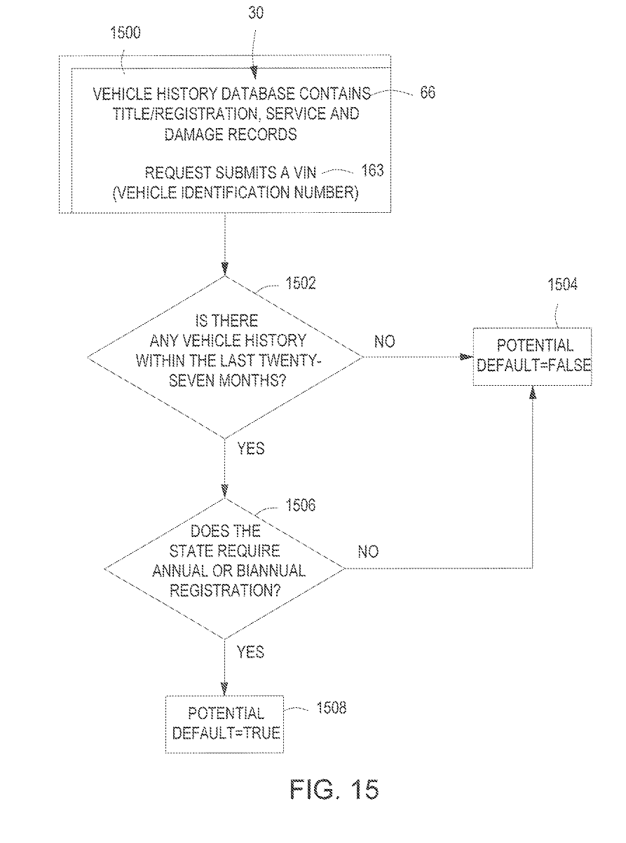

### FIG. 15

In FIG. 15, the background of the determining step 164 may be that the vehicle history database 30 may contain title/registration data variables, service and damage data variables, and the request submits a VIN 163. The logic of the embodiments may proceed through a decision process, asking “Is there any vehicle history within the last twenty-seven months?” 1502. If no, then potential default=false 1504. However, if yes, then it is asked, “Does the state require annual or biannual regulation?” 1506. If no, then potential default=false 1504. However, if yes, then potential default=true 1508.

Thus, the determining step may comprise determining that if there is a combination of an indication that there is not any vehicle history within the last twenty-seven months and the state requires annual or biannual registration, this may lead to a flagging of potential default. If there is no vehicle history within the last twenty-seven months, i.e. no, and annual or biannual registration is required, i.e. yes, then the determining step may determine that there is a higher risk for default because the vehicle's VIN has been cloned and the vehicle financing transaction may be fraudulent.

### EXAMPLE X

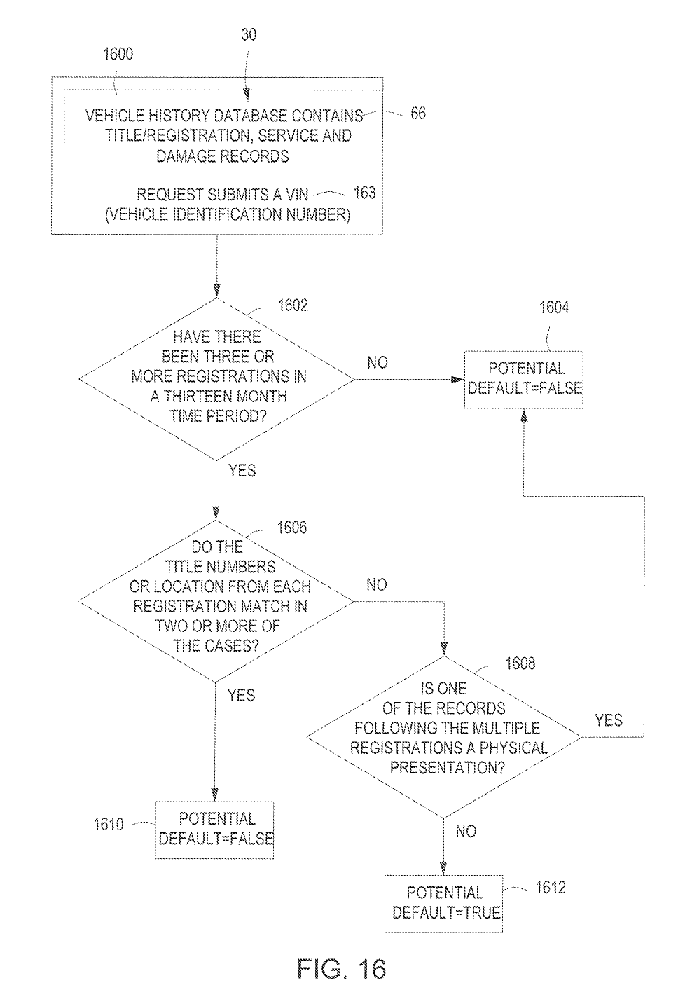

### FIG. 16

In FIG. 16, at 1600, the background of the determining step 164 may be that the vehicle history database 30 may contain title/registration data variables, service and damage data variables, and the request submits a VIN 163. The logic of the embodiments may proceed through a decision process, asking “Have there been three or more registrations in a thirteen month time period?” 1602. If no, then potential default=false 1604. However, if yes, then it is asked, “Do the title numbers or location from each registration match in two or more of the cases?” 1606. If yes, then potential default=false 1610. However, if no, then it is asked “Is one of the records following the multiple registrations a physical presentation?” 1608. If no, then potential default=true 1612. If yes, then potential default=false 1604. In this context, physically presented may indicate that the vehicle history service provider has received a record that the vehicle has been verified as a vehicle by a reputable source.

Thus, the determining step may comprise determining if, first, there is a combination of an indication that there have been three or more registrations in a thirteen-month period, second, that the title numbers or location from each registration do not match in two or more of the cases, and finally that none of the records following the multiple registrations is a physical presentation will lead to a flagging of potential default. That is, if three or more registrations in a thirteen-month period, i.e. yes, and no to both of the title number or location from each registration match in two or more of the cases (i.e. no), and one of the records following the multiple registrations is not a physical presentation, (i.e. no), then the determining step may determine that there is potential default because the vehicle's VIN has been cloned and the vehicle financing transaction may be fraudulent.

Thus the embodiments not only provide a method and system for predicting a risk of default associated with a vehicle financing transaction based on vehicle history, but also a method and system for generating information, i.e. overall value of one or more groups of data variables, values of individual data variables, a score, etc., useful in assessing risk related to default for loans. That is, the financing company may receive the value of one or more data variables, the overall value of one or more groups of data variables and/or a score or value, and then use that data to take action based on risk information, such as described herein.

The present disclosure is not to be limited in scope by the specific embodiments described herein. Indeed, other various embodiments of and modifications to the present disclosure, in addition to those described herein, will be apparent to those of ordinary skill in the art from the foregoing description and accompanying drawings. Thus, such other embodiments and modifications are intended to fall within the scope of the present disclosure. Further, although the present disclosure has been described herein in the context of at least one particular implementation in at least one particular environment for at least one particular purpose, those of ordinary skill in the art will recognize that its usefulness is not limited thereto and that the present disclosure may be beneficially implemented in any number of environments for any number of purposes. Accordingly, the claims set forth below should be construed in view of the full breadth and spirit of the present disclosure as described herein.

1. A method of determining risk of financing a vehicle comprising:
identifying a vehicle;
forming, in a physical memory of a data processing system, a plurality of data groupings using a processing device of the data processing system, wherein each of the plurality of data groupings includes at least one vehicle history data variable of the identified vehicle;
processing the at least one vehicle history data variable of at least one data grouping of the plurality of data groupings using the processing device of the data processing system;
determining an overall value of the at least one data grouping using the processing device of the data processing system; and
determining a risk of financing the identified vehicle based on the overall value of the at least one data grouping, using the processing device of the data processing system.

2. The method of claim 1, wherein the determining step comprises rating the financing of the identified vehicle based on the overall value of the at least one data grouping.

3. The method of claim 1, further comprising generating a score based upon an overall value of each of the plurality of data groupings and determining the risk of financing the identified vehicle based on the score.

4. The method of claim 3, wherein the score is calculated based on a weighted combination of the overall values of each of the plurality of data groupings.

5. The method of claim 4, wherein the score is a sum of the weighted overall values of each of the plurality of data groupings represented as a mathematical equation.

6. The method of claim 1, wherein the step of determining an overall value is based on whether a vehicle possesses or does not possess a characteristic of at least some of said at least one vehicle history data variable.

7. The method of claim 1, wherein the at least one vehicle history data variable formed within the at least one data grouping comprises a plurality of similar vehicle history data variables.

8. The method of claim 7, wherein the similarity of the plurality of vehicle history data variables within the at least one data grouping includes being similar in at least one of type and default rate.

9. The method of claim 3, wherein the score is characterized as at least one of a number, mark, symbol, and color.

10. A non-transitory computer readable media comprising code to perform the steps of the method of claim 1.

11. An apparatus for determining risk of financing a vehicle comprising:
means for identifying a vehicle;
means for forming a plurality of data groupings, wherein each of the plurality of data groupings includes at least one vehicle history data variable of the identified vehicle;
means for processing the at least one vehicle history data variable of at least one data grouping of the plurality of data groupings;
means for determining an overall value of the at least one data grouping; and
means for determining a risk of financing the identified vehicle based on the overall value of the at least one data grouping.

12. The apparatus of claim 11, wherein the means for determining comprises means for rating the financing of the identified vehicle based on the overall value of said at least one data grouping.

13. The apparatus of claim 11, further comprising means for generating a score based upon an overall value of each of the plurality of data groupings and determining the risk of financing the identified vehicle based on the score.

14. The apparatus of claim 13, wherein the score is calculated based on a weighted combination of the overall values of each of the plurality of data groupings.

15. The apparatus of claim 14, wherein the score is a sum of the weighted overall values of each of the plurality of data groupings represented as a mathematical equation.

16. The apparatus of claim 13, wherein the score is characterized as at least one of a number, mark, symbol, and color.

17. The apparatus of claim 11, wherein the means for determining an overall value comprises means for determining the overall value based on whether a vehicle possesses or does not possess a characteristic of at least some of the at least one vehicle history data variable.

18. The apparatus of claim 11, wherein the at least one vehicle history data variable formed within the at least one data grouping comprises a plurality of similar vehicle history data variables.

19. The apparatus of claim 17, wherein the similarity of the plurality of vehicle history data variables within the at least one data grouping includes being similar in at least one of type and default rate.

20. The apparatus of claim 11, wherein the overall value is indicative of the likelihood of incurring future default.
